(19) United States
(12) Patent Application Publication
(10) Pub. No.: US 2010/0224687 A1
(43) Pub. Date: Sep. 9, 2010

(54) Information Indicating Memory Mark

(75) Inventor: Morita Hiroyoshi, Tokyo (JP)

Correspondence Address: APEX JURIS, PLLC, 12733 LAKE CITY WAY NORTHEAST, SEATTLE, WA, 98125, US

(73) Assignees: GLOBAL PEACE AND ENVIRONMENT CENTER, INC., Tokyo (JP); SUSTAINABLE EARTH INSTITUTE, INC., Tokyo (JP); EX-ONE INTERNATIONAL, INC., Tokyo (JP)

(21) Appl. No.: 11/568,979

(22) PCT Filed: May 31, 2006
(86) PCT No.: PCT/JP2006/310910

§ 371 Date: Nov. 11, 2006

(51) Int. Cl. G06K 19/06

(52) U.S. Cl. 235/494

(57) ABSTRACT

An information display memory mark is comprised of a many-sided figure with many cells combined vertically and horizontally and includes at least of a first element, a second element and a data unit. The information display memory mark is characterized in that the first element and the second element represent a cell size and a direction of each side of the information display memory mark as detectable data and the second element is disposed at at least one corner out of individual ones of the information display memory mark and the first element is disposed at the number of corners different from the second element out of the remaining individual corners, so that top, bottom, left and right of the information display memory mark can be detected.

### TECHNICAL FIELD

The present invention relates to an information indicating memory mark adapted to be read by a specified reader for indicating specified information, or in particular to an information indicating memory mark high in detection accuracy of top, bottom, left and right sides, the direction in which the cells on each side are arranged and the cell width of the information indicating memory mark and having a high multi-purpose function of the whole profile.

### BACKGROUND ART

A technique is generally known in which an information indicating memory mark is attached on a given object and imaged by an imaging means such as a scanner or a digital camera, and the imaged data are analyzed by a dedicated software thereby to retrieve the information stored in the information indicating memory mark.

A two-dimensional code or the like is known as the conventional information indicating memory mark.

The two-dimensional code available includes a stack type with ordinary bar codes stacked vertically and a matrix two-dimensional code encoded according to whether the matrix intersection is black or white. The two-dimensional codes of stack and matrix types have apparently different features. In a stack type bar code, the bar codes are stacked to form a code after all, and start and stop codes are required. This is a code emphasizing the importance of being read with the bar code at the same time using the conventional scanner such as a laser scanner. The matrix type, on the other hand, emphasizes the importance of information density and size. Normally, the height of the stack type bar, taking the reading by the laser scanner into consideration, is required to be three to ten times as large as the module width. The matrix type, therefore, has the information density three to ten times as large as the stack type.

The box code is known as one of the ordinary two-dimensional codes. The box code, as shown in the patent document described below, is a box-shaped information indicating memory mark including a plurality of square base units. A plurality of similar rectangles (elements) are arranged concentrically and each side of the rectangle is cut off to express information. Each element can store four-bit information. Also, in the ordinary box code, four squares of different sizes are arranged concentrically, and each side of each square, as one bit, is selectively cut off thereby to express the information of 16 bits in total.

The QR code is well known as another ordinary two-dimensional code.

In the QR code, data portions are arranged vertically and horizontally and as a cut-out symbol for position detection, an element formed of a solid rectangle and a rectangle arranged on the outer periphery thereof is arranged at three corners. In this way, the whole code can be cut out, while at the same time detecting the origin, the symbol size and the inclination.

### Patent Document 1. Japanese Examined Patent Publication No. 2788439.

Non-Patent Document. QR code

“http://www.denso-wave.com.qrcode/aboutqr.html”

### DISCLOSURE OF THE INVENTION

### Problem to be Solved by the Invention

The conventional information indicating mark, however, poses the problems described below.

(1) The box code can store information only up to 4 bits per element, and is not suitable for storing information of large capacity.

(2) Although the QR code can store a large amount of data as compared with the box code described above, the detection accuracy of the cut-out symbol is so low that it is difficult to read the data fast and accurately.

In addition, in order to make up for the problem of the data detection accuracy, a large area is required to be secured for the error correction code used in the QR code, resulting in a giant QR code as a whole.

(3) Partly because the QR code is unified according to JIS standard, the cell length variations and the cut-out symbol patterns (sizes) are limited to about 40 kinds, resulting in the lack of multi-purpose functions.

Accordingly it is an object of the present invention to provide an information indicating memory mark detectable with high speed and accuracy as compared with the conventional information indicating memory mark and having a multi-purpose overall profile.

### Means for Solving the Problem

In order to achieve the object described above, according to a first invention, there is provided a polygonal information indicating memory mark having a plurality of cells combined in two directions, comprising at least first elements, a second element and a data portion, characterized in that the first elements include a plurality of direction detectors each with a plurality of cells continuously arranged in two different directions, the plurality of the direction detectors are arranged radially in predetermined spaced relation with each other, the second element includes the direction detector and a dimension detector with a plurality of cells arranged intermittently in the two directions designated by the direction detector, the second element is arranged in at least one position, and the first elements different in number from the second element are arranged.

According to a second invention, there is provided an information indicating memory mark as described in the first invention, characterized in that a margin is formed on the outer periphery of the information indicating memory mark.

According to a third invention, there is provided an information indicating memory mark as described in the first or second invention, further comprising a third element, characterized in that the third element has a plurality of cells arranged intermittently in a specified direction.

According to a fourth invention, there is provided an information indicating memory mark as described in any one of the first to third inventions, further comprising a fourth element, characterized in that the fourth element represents the information designating the form of the data portion.

According to a fifth invention, there is provided an information indicating memory mark as described in any one of the first to fourth inventions, further comprising a fifth element, characterized in that the fifth element indicates to the degree of error correction of the data portion.

According to a sixth invention, there is provided an information indicating memory mark as described in any one of the first to fifth inventions, further comprising a sixth element, characterized in that the sixth element represents a line number indication unit for indicating the line number of itself and a last line indication unit for indicating whether it is the last line or not.

According to a seventh invention, there is provided an information indicating memory mark characterized in that a plurality of the information indicating memory marks as described in the sixth invention are stacked thereby to form an integrated code.

According to an eighth invention, there is provided an information indicating memory mark as described in any one of the first to seventh inventions, characterized in that the information indicating memory mark is rectangular.

According to a ninth invention, there is provided an information indicating memory mark as described in the eighth invention, characterized in that the first elements are arranged at three out of the four corners of the rectangular information indicating memory mark, and the second element is arranged at the remaining one corner.

According to a tenth invention, there is provided an information indicating memory mark as described in the ninth invention, characterized in that the first elements include divisions of a box code, each division is divided into four subdivisions assigned an apex of the box code having continuous sides, and three of the four types of the subdivisions are assigned to each corner.

### EFFECTS OF THE INVENTION

As described above, according to the present invention, at least one of the effects described below can be obtained.

(1) The detection accuracy and speed of the direction of cell arrangement on each side and the cell width of the information indicating memory mark is higher than those of the conventional information indicating memory mark. As a result, the accuracy with which the data portion is read is also high, and therefore, the intensity of the error correction code can be reduced as compared with the prior art. The area in which the data portion is assigned per code is also of course increased, thereby contributing to the minimization of the code.

(2) The data portion that can be arranged per code of the information indicating memory mark can be freely increased or decreased in the directions along rows and columns. In addition, by stacking a plurality of information indicating memory marks in multiple stages in the direction along the rows, an integrated information indicating memory mark can be created. Therefore, the desired information indicating memory mark can be provided which has a wealth of variations of the overall profile and high in multi-purpose applicability due to the information amount stored and the intensity of the error correction.

### BRIEF DESCRIPTION OF THE DRAWINGS

FIG. 1 is a diagram showing an information indicating memory mark according to a first embodiment of the invention.

FIG. 2 is a diagram for explaining the detail of the first elements in FIG. 1.

FIG. 3 is a diagram for explaining the detail of the second element in FIG. 1.

FIG. 4 is a diagram for explaining the detail of the third element in FIG. 1.

FIG. 5 is a diagram for explaining the detail of the fifth element in FIG. 1.

FIG. 6 is a diagram for explaining the detail of the last line indication unit shown in FIG. 1.

FIG. 7 is a diagram showing an information indicating memory mark according to a second embodiment of the invention.

FIG. 8 is a diagram showing an information indicating memory mark according to a third embodiment of the invention.

FIG. 9 is a diagram showing an information indicating memory mark according to a fourth embodiment of the invention.

FIG. 10 is a diagram showing an information indicating memory mark according to a fifth embodiment of the invention.

### BEST MODE FOR CARRYING OUT THE INVENTION

Embodiments of the invention are explained below with reference to the drawings.

The cells used in this explanation have the same size and shape, and the vertical and horizontal directions and the directions of the matrix are based on the directions described in the drawings. The black solid cells represent “1” (high level) information, and the cells not solid the information of “0” (low level) information.

### Embodiment 1

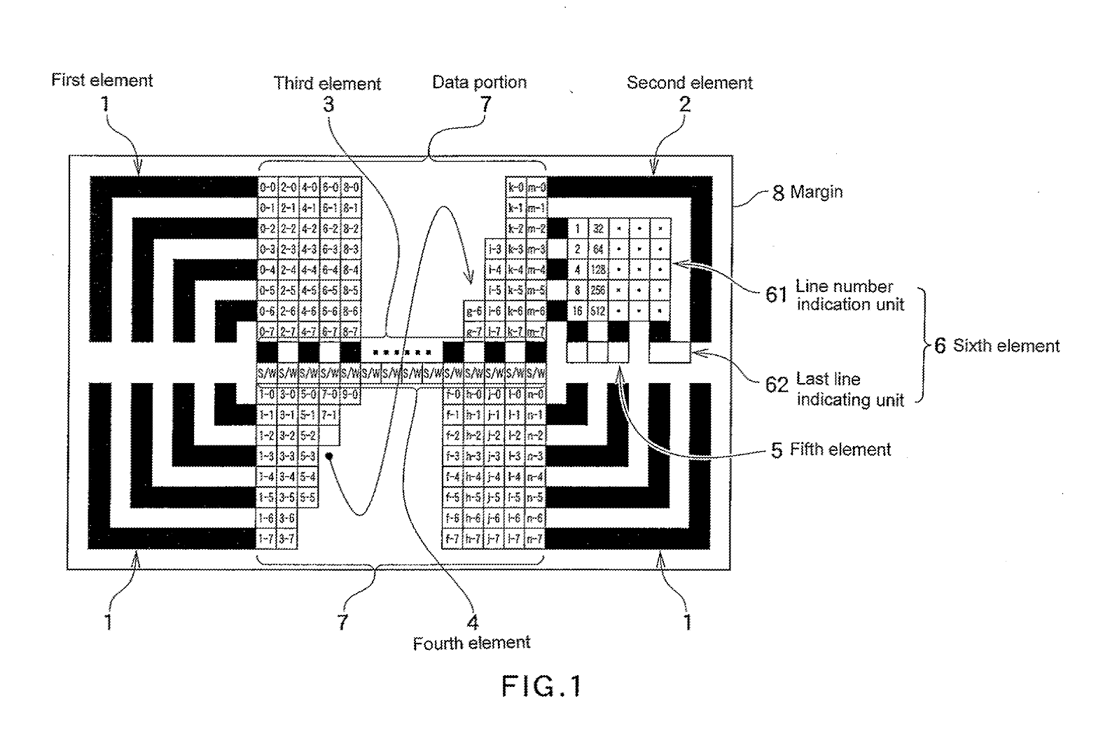

FIG. 1 is a diagram showing the information indicating memory mark according to a first embodiment of the invention.

The information indicating memory mark shown in FIG. 1 is a rectangular two-dimensional code having a multiplicity of cells combined in vertical and horizontal directions with four corners of upper left, lower left, upper right and lower right corners. This information indicating memory mark includes first elements 1, a second element 2, a third element 3, a fourth element 4, a fifth element 5, a sixth element 6, a data portion 7 and a margin 8.

### First Element

The first elements are explained. The first elements 1 are different in number from the second element described later and represent the information by which the direction and cell width of each side of particular information indicating memory mark can be detected.

The first elements 1 include a plurality of direction detectors each having a plurality of cells arranged continuously in two different directions, which direction detectors are arranged radially in predetermined spaced relation with each other.

More specifically, the direction detectors represent the information for detecting the directions of the two sides crossing at a corner of the information indicating memory mark. A plurality of the direction detectors are arranged radially in predetermined spaced relation and make up an element representing the information on the cell width (length), i.e. the cell size of each cell detectable in the direction in which the cells are arranged on the two sides described above.

According to this embodiment, the first elements 1 are arranged at three corners including the upper left, lower left and lower right corners of the four corners of the information indicating memory mark.

In this arrangement, the top, bottom, left and right sides of the particular information indicating memory mark can be detected by combining the first elements 1 and the second element 2 described later.

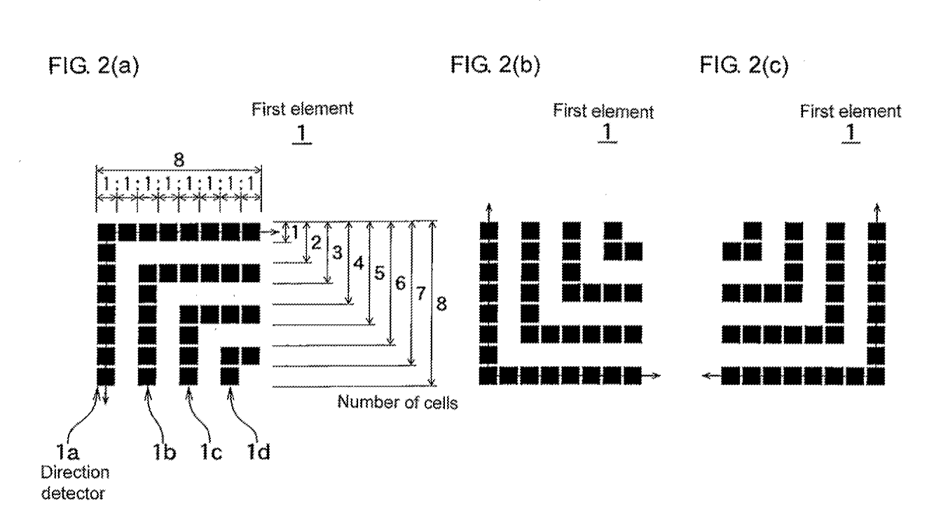

FIG. 2 is a diagram showing the three types of the first elements in FIG. 1 in detail.

The first element 1 according to this embodiment is configured of the conventional box code, i.e. a plurality of similar rectangles arranged concentrically (radially) and divided into four equal parts including upper, lower, left and right parts. Three of these four divisions are each used as an individual first element.

The box code is, though not essentially, divided desirably into parts of the same size in order to detect the direction of each side and the width of each cell making up the information indicating memory mark uniformly without accuracy difference in all directions.

FIG. 2(a) shows the first element 1 arranged at the upper left corner of the information indicating memory mark shown in FIG. 1, FIG. 2(b) the first element 1 arranged at the lower left corner of the information indicating memory mark shown in FIG. 1, and FIG. 2(c) the first element 1 arranged at the lower right corner of the information indicating memory mark shown in FIG. 1. In FIGS. 2(a) to (c), the cells are shown, though not essentially, arranged with a minuscule gap therebetween for convenience' sake.

With reference to FIG. 2(a), the first element 1 arranged at the upper left corner is explained. The first element 1 arranged at the upper left corner forms a square having 8×8 cells for a total of 64 cells.

Specifically, the first element 1 arranged at the upper left corner is configured of the cells arranged as described below.

First line: “11111111”

Second line: “10000000”

Third line: “10111111”

Fourth line: “10100000”

Fifth line: “10101111”

Sixth line: “10101000”

Seventh line: “10101011”

Eighth line: “10101010”

As clear from the foregoing description, the first element 1 is configured of similar L-shaped direction detectors 1a, 1b 1c, 1d arranged in an apparently radial form.

Next, with reference to FIG. 2(b), the first element 1 arranged at the lower left corner is explained. As explained above with reference to FIG. 2(a), the first element 1 arranged at the lower left corner forms a square having 8×8 cells for a total of 64 cells.

Specifically, the first element 1 arranged at the lower left corner is configured of the cells arranged as described below.

First line: “10101010”

Second line: “10101011”

Third line: “10101000”

Fourth line: “10101111”

Fifth line: “10100000”

Sixth line: “10111111”

Seventh line: “10000000”

Eighth line: “11111111”

Next, with reference to FIG. 2(c), the first element 1 arranged at the lower right corner is explained. As explained above with reference to FIG. 2(a), the first element 1 arranged at the lower right corner forms a square having 8×8 cells for a total of 64 cells.

Specifically, the first element 1 arranged at the lower right corner is configured of the cells arranged as described below.

First line: “01010101”

Second line: “11010101”

Third line: “00010101”

Fourth line: “11110101”

Fifth line: “00000101”

Sixth line: “11111101”

Seventh line: “00000001”

Eighth line: “11111111”

### Second Element

The second element 2 includes a direction detectors included in the first element and a size detector with a plurality of cells arranged intermittently in the two directions designated by the particular direction detector. The second element thus represents the information by which the direction of each side and the cell width of the information indicating memory mark can be detected. Also, in combination with the first element 1 described above, the second element represents the information by which the top and the bottom of the particular information indicating memory mark can be detected. According to this embodiment, the second element 2 is arranged only at the upper right corner.

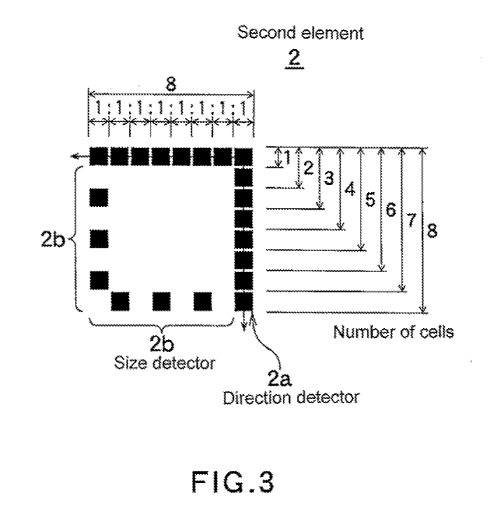

FIG. 3 is a diagram showing the detail of the second element 2 shown in FIG. 1. In FIG. 3, the cells are shown arranged with a minuscule gap therebetween for convenience' sake. Like in FIG. 2, however, the minuscule gap between the cells is not an essential factor.

With reference to FIG. 3, the second element 2 is explained.

The second element 2 includes a direction detector 2a with a plurality of cells arranged continuously in two different directions and a size director 2b with a plurality of cells arranged intermittently in the two directions designated by the direction detector 2a.

Specifically, the second element 2 shown in FIG. 3 has the cells arranged as described below.

First line: “11111111”

Second line: “00000001”

Third line: “10000001”

Fourth line: “00000001”

Fifth line: “10000001”

Sixth line: “00000001”

Seventh line: “10000001”

Eighth line: “01010101”

### Third Element

The third element 3 represents the information for detecting a predetermined direction and the cell length.

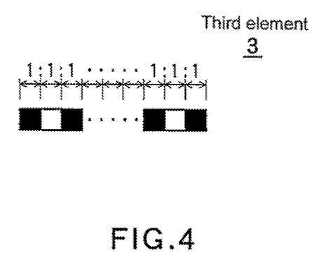

FIG. 4 is diagram showing the detail of the third element 3 according to this embodiment.

As shown in FIG. 4, the third element 3 is arranged across the columns of the data portion. In order to detect the linear direction in which the cells of the third element 3 are arranged, cells “1” and cells “0” are arranged alternately on the straight line along the columns.

In the process, the cells “1” are always required to be arranged at the left and right ends of the third element 3.

### Fourth Element

The fourth element 4 represents the information designating the method of reading the data portion.

The fourth element 4 according to this embodiment, like the third element 3, is arranged on the straight line crossing the columns and has stored therein the information designating the method of detecting data for each column of the data portion 7 of the information indicating memory mark.

In the case where the fourth element 4 for a given column is “0”, for example, it indicates the single byte mode, in which case one byte of the data portion arranged above and below the fourth element 4 are handled as independent data.

In the case where the fourth element 4 in a given column is the cell “1”, it indicates the double byte mode, and one byte of the data portion arranged above and below the fourth element 4 are handled as 2-byte data.

### Fifth Element

The fifth element 5 has the feature that it is an error correction code for the data portion.

As shown in FIG. 1, the fifth element 5 according to this embodiment is arranged between the second element 2 and the first element 1 arranged at the lower right corner of the information indicating memory mark.

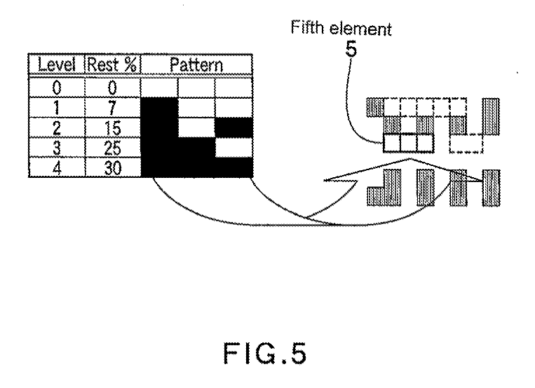

FIG. 5 is a diagram showing the detail of the fifth element 5 used in this embodiment.

Various codes known in the prior art can be used as the error correction code of the fifth element. According to this embodiment, the 3-bit Reed-Solomon code is used, in which five error correction levels can be selected.

### Sixth Element

The sixth element 6 represents a line number indication unit 61 indicating the line number of itself and a last line indication unit 62 indicating whether it is the last line or not.

As shown in FIG. 1, the line number indication unit 61 included in the sixth element 6 is arranged in the internal space of the second element 2, and the last line indication unit 62 is arranged between the second element 2 and the first element 1 arranged at the lower right corner of the information indicating memory mark.

The line number indication unit 61 is a square having 25 (=5×5) cells and can indicate up to 2²⁵ lines.

The information indicating memory mark shown in FIG. 1 is a code to be read individually, and therefore ends at the first line. In the line number indication unit 61, therefore, the cell “0” is arranged for all of the 25 cells.

In the case where the combination of the line number indication unit 61 and the second element 2 is symmetric with the first element 1, the first element and the second element would be confused with each other, and the function of detecting the top, bottom, left and right sides of the second element would be lost. Therefore, the line number indication unit 61 lacks the following cell arrangement:

First line: “11111”

Second line: “00001”

Third line: “11101”

Fourth line: “00101”

Fifth line: “10101”

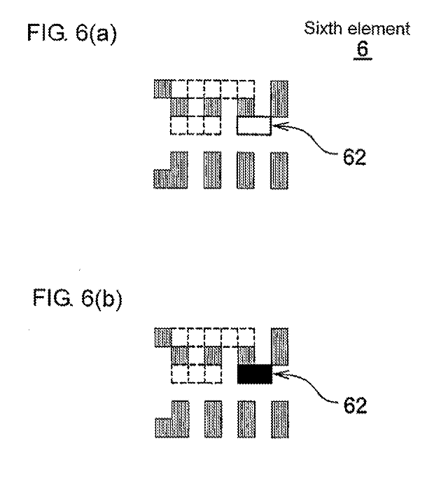

FIG. 6 is a diagram showing the last line indication unit 62 in detail.

The last line indication unit 62 uses two cells, and in the case where the information indicating memory mark is the last line, cells “00” are arranged, while cells “11” are arranged in the case where the information indicating memory mark is a still continuing line.

Referring to FIG. 1, the information indicating memory mark according to this embodiment is a code to be read individually, and therefore, the last line indication unit 62 has the cell arrangement “00”.

### Data Portion

The data portion 7 has stored therein characters, images, voices, dynamic images, programs or any combination thereof, or these information encrypted in advance.

As to the method of data arrangement, the data are arranged by an arrangement method appropriately determined with the means (a reader or a read program) for reading the information indicating memory mark according to the invention.

### Margin

The margin 8 is a margin as large as one cell over the outer periphery of the information indicating memory mark, and desirably formed for the convenience of reading the information indicating memory mark. The provision of the margin can prevent the erroneous detection of the information indication memory mark.

### Image Correction Process Before Reading Data Portion

An explanation is made about a method of detecting the cell width (size), the direction in which cells are arranged on each side and the top, bottom, left and right sides, using the first, second or third element according to this embodiment.

### 1. Detection of Cell Arrangement Direction

The direction detector is used for detection of the direction in which the cells on each side of the first elements 1 and the second element 2 are arranged. Specifically, taking advantage of the fact that the cells “1” are continuously arranged along the rows and columns of the rectangular information indicating memory mark, the direction in which the cells are arranged on each side is specified by the software of the reader, and before reading the data portion 7, the image processing such as the inclination correction of the information indicating memory mark is carried out.

Also in the third element 3, taking advantage of the fact that a plurality of cells are arranged intermittently in a specified direction, the direction in which the cells are arranged is specified by the software of the reader, and before reading the data portion 7, the image processing is carried for correction of the inclination of the information indicating memory mark.

### 2. Detection of Cell Width (Size)

The detection of the cell width by the first elements 1 utilizes the fact that a plurality of direction detectors 1a, 1b, 1c, 1d are arranged radially in predetermined spaced relation with each other. Specifically, taking advantage of the fact that the cells “1” and “0” are arranged alternately in the directions of the rows and columns of the rectangular information indicating memory mark, the cell width of each side is specified the software of the reader before reading the data portion 7.

### 3. Detection of Top, Bottom, Left and Right Sides

The detection of top, bottom, left and right sides of the information indicating memory mark according to the present invention is based on the manner in which the first and second elements are arranged.

The second element shown in FIG. 1 is arranged at the upper right corner of the information indicating memory mark. After the second element is recognized by the software of the reader before the data portion 7 is read, the image processing is carried out in which the information indicating memory mark that has been read is arbitrarily rotated.

Incidentally, for detecting the top, bottom, left and right sides of the information indicating memory mark, the first elements and the second elements only need to be different in number from each other are arranged and the invention is not limited to this embodiment.

The detection process described in 1 to 3 above can be executed in any order by the reader software, and a similar effect can be obtained by simultaneous execution.

### Embodiment 2

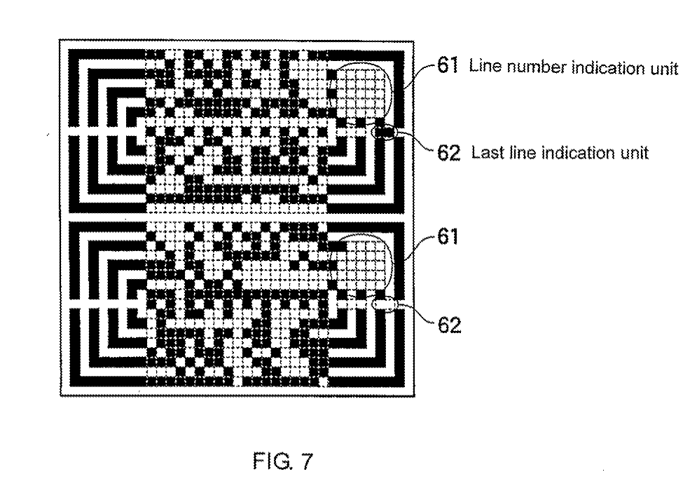

FIG. 7 is a diagram showing an information indicating memory mark according to a second embodiment of the invention.

As shown in FIG. 7, the information indicating memory mark according to the first embodiment can be formed in a plurality of layers along the rows.

Incidentally, each element is similar to that of the first embodiment, and therefore not explained again.

According to this embodiment, as shown in FIG. 7, “0” is arranged for all of the 25 cells as the information indicating that the line number indication unit 61 of the sixth element of in the information indicating memory mark in the upper stage is in the first stage, and “11” is arranged for the last line indication unit 62. Also, in the line number indication unit 61 of the information indicating memory mark in the lower stage, the information indicating the second stage, i.e. “1” is arranged only for the first cell, the remaining 24 cells being “0”. The information indicating memory mark in the second stage is the last line, and therefore, “00” is arranged for the last line indication unit 62.

With this configuration, a plurality of the information indicating memory marks in stack can be recognized as an integrated information indicating memory mark.

### Embodiment 3

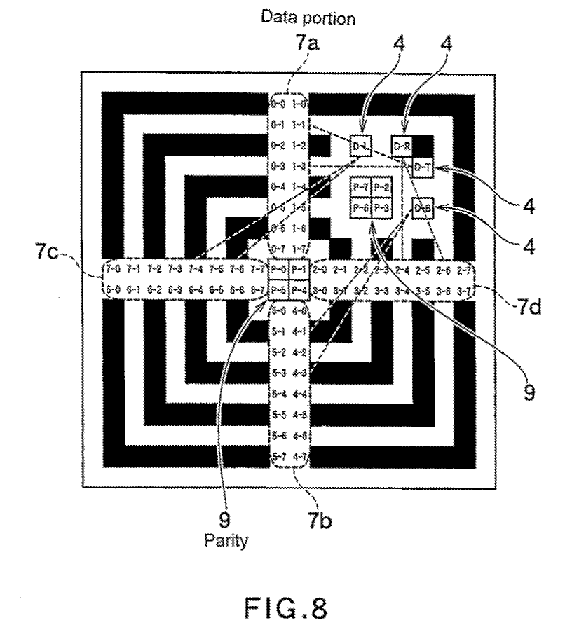

FIG. 8 is a diagram showing the information indicating memory mark according to a third embodiment of the invention.

The information indicating memory mark sown in FIG. 8 is a square code and includes first elements 1, a second element 2, fourth elements 4, a data portion 7, a margin 8 and parities 9. The parity 9 is either an odd number or an even number.

The first elements are arranged at three of the four corners of the information indicating memory mark, and the second element is arranged at the remaining one corner. The first elements and the second element are similar to those of the first embodiment and therefore not described again.

Of the parities 9, the first parity is generated by the cells 0-0 to 0-7 of the data portion, and stored in the cell described as P-0. Also, the cells 1-0 to 7-7 of the data portion are used to generate the second to eighth parities by repeating a similar process, which parities are stored in P-1 to P-8 in that order.

The fourth elements 4 are arranged intermittently in the shape of L in the area defined by the second element 2.

The cell “0” indicates the reading method in single byte mode, and the cell “1” the reading method in double byte mode.

Of the fourth elements 4 shown in FIG. 8, the cell designated as D-T represents the manner in which the upper data portion 7a of the data portion 7 arranged in a cross is read. In similar fashion, the cells designated as D-B, D-L, D-R represent the manner in which the lower, left and right data portions 7b, 7c, 7d, respectively, are read.

The method of detecting the 2-byte data and the position where the fourth elements are arranged in double byte mode can be appropriately determined in accordance with the specification and not limited to this embodiment.

### Embodiment 4

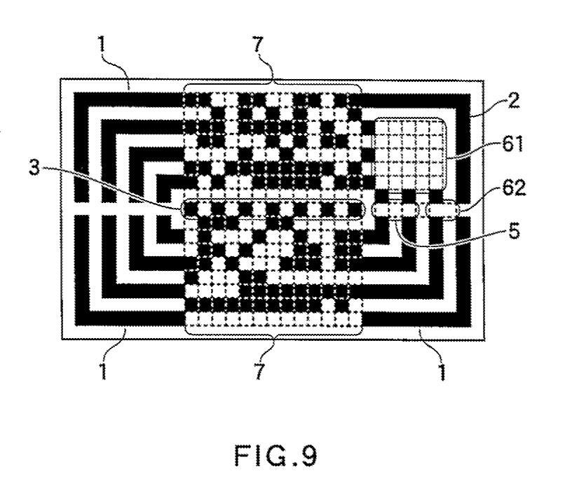

FIG. 9 is a diagram showing the information indicating memory mark according to a fourth embodiment of the invention.

The information indicating memory mark shown in FIG. 9 includes first elements 1, a second element 2, a third element 3, a fifth element 5, a sixth element 6, data portions 7, and a margin 8.

Each element is similar to that of the first element and therefore not described again.

### Embodiment 5

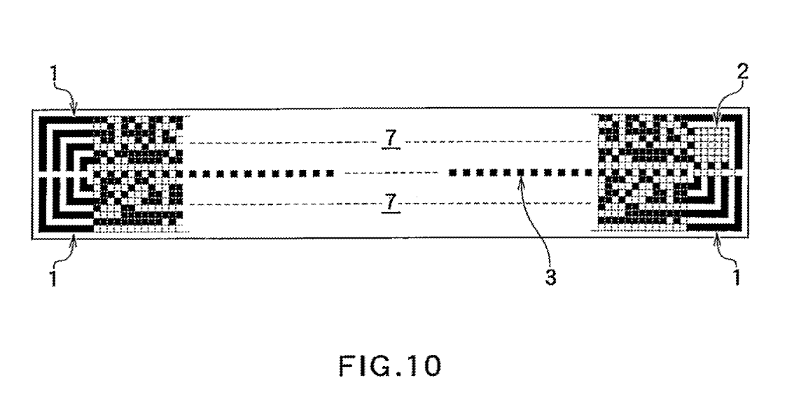

FIG. 10 is a diagram showing the information indicating memory mark according to a fifth embodiment of the invention.

In the information indicating memory mark according to the fifth embodiment, as compared with the information indicating memory mark having the configuration of the fourth embodiment, the data portions 7 are extended along the direction of the columns.

Each element is similar to that of the first embodiment and therefore not described again.

Even in the case where the data portions 7 are extended long along the direction of the columns as shown in FIG. 10, the third element compensates for the direction along the columns between the data portions 7 and therefore a high detection accuracy can be secured.

### Other Embodiments

The method of indicating the cells of the information indicating memory mark as “1” (high level) or “0” (low level) according to the present invention is not limited to this embodiment.

For example, the information of “1” (high level) information of the cells can be indicated by a material luminescent (natural luminescence) in the dark or by changing the cell tone.

Also, the cell is not necessarily a square in shape, but other polygonal cells or a circular cell can be used in accordance with the beautiful appearance required of the information indicating memory mark or the reading accuracy of the reader.

### DESCRIPTION OF REFERENCE NUMERALS

1: First element
1a, 1b, 1c, 1d: Direction detector
2: Second element
2a: Direction detector
2b: Size detector
3: Third element
4: Fourth element
5: Fifth element
6: Sixth element
61: Line number indication unit
62: Last line indication unit
7: Data portion
8: Margin
9: Parity

1. A polygonal information indicating memory mark having a plurality of cells combined in two directions, characterized in that
the information indicating memory mark includes at least first elements, a second element and a data portion,
the first elements each include a plurality of direction detectors with a plurality of cells arranged continuously in two different directions, and the plurality of the direction detectors are arranged radially in predetermined spaced relation with each other,
the second element includes the direction detector and a size detector with a plurality of cells arranged intermittently in the two directions designated by the direction detector, and
the second element is arranged in at least one position, and the first elements in the number different from the second element are arranged.

2. An information indicating memory mark according to claim 1, characterized in that a margin is arranged on the outer periphery of the information indicating memory mark.

3. An information indicating memory mark according to claim 1 or 2, further comprising a third element, characterized in that the third element has a plurality of cells arranged intermittently in a specified direction.

4. An information indicating memory mark according to any one of claims 1 to 3, further comprising a fourth element, characterized in that the fourth element represents the information for designating the form of the data portion.

5. An information indicating memory mark as set forth any one of claims 1 to 4, further comprising a fifth element, characterized in that the fifth element represents the degree of error correction of the data portion.

6. An information indicating memory mark according to any one of claims 1 to 5, further comprising a sixth element, characterized in that the sixth element represents a line number indication unit for indicating the line number of itself and a last line indication unit for indicating whether it is the last line or not.

7. An information indicating memory mark characterized in that a plurality of the information indicating memory marks according to claim 6 are stacked thereby to form an integrated code.

8. An information indicating memory mark according to any one of claims 1 to 7, characterized in that the information indicating memory mark is rectangular.

9. An information indicating memory mark according to claim 8, characterized in that the first elements are arranged at three out of the four corners of the rectangular information indicating memory mark, and the second element is arranged at the remaining one corner.

10. An information indicating memory mark according to claim 9, characterized in that the first elements each include divisions of a box code, each division is subdivided into four parts assigned each apex of the box code having continuous sides, and three out of the four subdivisions are assigned to and arranged at the corners, respectively.
